(19) United States
(12) Patent Application Publication
(10) Pub. No.: US 2014/0189691 A1
(43) Pub. Date: Jul. 3, 2014

(54) INSTALLATION SYSTEM AND METHOD

(71) Applicants: HON HAI PRECISON INDUSTRY CO., LTD, New Taipei (TW); HONG FU JIN PRECISION INDUSTRY (ShenZhen) CO., LTD, Shenzhen (CN)

(72) Inventors: CHUNG-I LEE, New Taipei (TW); YI-GUO WANG, Shenzhen (CN); KUAN-CHIAO PENG, New Taipei (TW); JIAN HUANG, Shenzhen (CN)

(73) Assignees: HON HAI PRECISON INDUSTRY CO., LTD, New Taipei (TW); HONG FU JIN PRECISION INDUSTRY (ShenZhen) CO., LTD, Shenzhen (CN)

(21) Appl. No.: 14/135,683

(22) Filed: Dec. 20, 2013

(30) Foreign Application Priority Data
Dec. 28, 2012 (CN) 2012105840497

(51) Int. Cl. G06F 9/455

(52) U.S. Cl. CPC G06F 9/45533
USPC 718/1

(57) ABSTRACT

A remote computer is connected to a plurality of cloud servers of a data center. The remote computer obtains parameters of each cloud server and determines available cloud servers. The remote computer calculates an installation coefficient of each available cloud server according to the parameters of the available cloud server. The remote computer installs the virtual machine in the available cloud server according to a maximum installation coefficient.

### BACKGROUND

1. Technical Field

Embodiments of the present disclosure relate to monitoring technology, and particularly to a system and method for monitoring virtual machines in cloud servers of a data center.

2. Description of Related Art

A virtual machine (VM) is a software implementation that virtualizes a computer or a server on an operating system (kernel) layer. By using VMs, multiple operating systems can co-exist and run independently on the same computer. However, before installing the VM on the computer, a user may need to manually check if the computer is capable of running a VM. For example, the user may check if the computer has enough random access memory or enough storage capacity on its mass storage device for the VM. If the virtual machines need to be installed on a large number of computers, manually checking each computer is inconvenient and inefficient. Thus, there is room for improvement in the art.

### BRIEF DESCRIPTION OF THE DRAWINGS

FIG. 1 is a schematic block diagram of one embodiment of an installation system.

FIG. 2 is a block diagram of one embodiment of a remote computer included in FIG. 1.

FIG. 3 is a flowchart of one embodiment of an installation method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

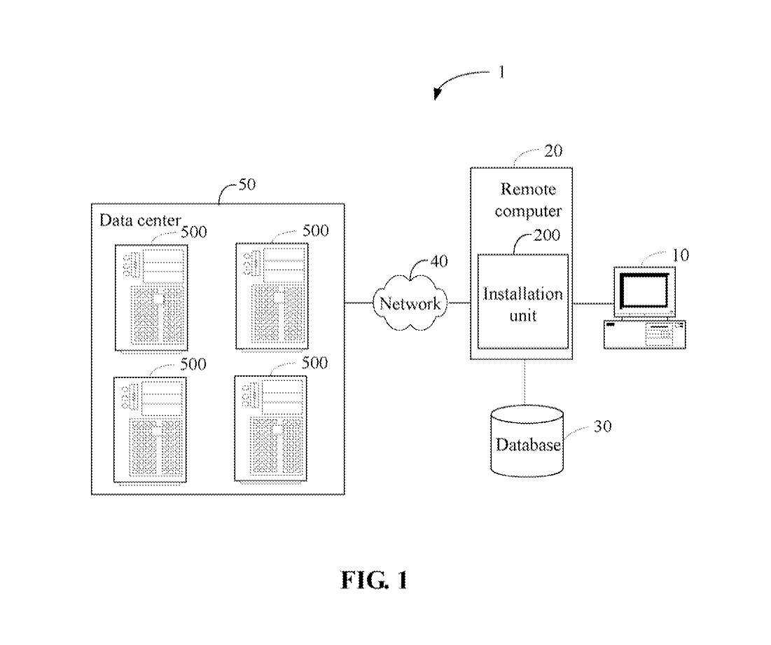

FIG. 1 is a system view of one embodiment of an installation system 1. The installation system 1 may include a remote computer 20 and a data center 50. The data center 50 includes a plurality of cloud servers 500 and is designed for cloud computing capability and capacity. The remote computer 20 is connected to the data center 50 via a network 40. The network 40 may be, but is not limited to, a wide area network (e.g., the Internet) or a local area network. The installation system 1 may be used to install virtual machines in each cloud server 500. Using open database connectivity (ODBC) or JAVA database connectivity (JDBC), for example, the remote computer 20 is connected to a database system 30. The database system 30 may store data obtained from each cloud server 500 by the remote computer 20. Additionally, the remote computer 20 is connected to one or more client computers 10, and each of the one or more client computers 10 provides an operation interface for controlling one or more operations of the remote computer 20.

The remote computer 20 stores one or more image files. Each image file is defined as a compressed file that contains complete contents and structures of an operating system. Each image file includes an installation process of a virtual machine and an activation process of the virtual machine. In one embodiment, if the image file is deployed into the cloud servers 500, then the virtual machine is installed into the cloud servers 500 and is activated to be available for use. In other words, a user can use the image file to install one or more virtual machines in the cloud servers 500. The remote computer 20 further stores a virtual machine controlling application. The virtual machine controlling application is defined as a software application that deploys the one or more image files in the cloud servers 500. The virtual machine controlling application may be, but is not limited to, a VMWARE VCENTER. Furthermore, in order to manage the one or more virtual machines, each cloud server 500 installs a virtual machine management application (e.g., HYPERVISOR). The HYPERVISOR is used to manage and monitor execution of the one or more virtual machines.

The remote computer 20 obtains parameters of each cloud server 500. The parameters of the cloud server 500 include a number of cores of the CPU in the cloud server 500, a storage capacity of a memory (e.g., random access memory) in the cloud server 500, a storage capacity of a disk in the cloud server 500, a speed of an interface of the disk in the cloud server 500, a speed of an interface of a network interface card (NIC) in the cloud server 500, a disk utilization rate of the cloud server 500, a memory utilization rate of the cloud server 500, a CPU utilization rate of the cloud server 500, and a network interface card (NIC) utilization rate of the cloud server 500. The parameters of each cloud server 500 further includes a serial number of the cloud server 500, a voltage of the cloud server 500, a rotational speed of a fan of the cloud server 500, a temperature of the cloud server 500, a status of the cloud server 500 (e.g., power on/off), a disk type, a memory type, and a NIC type, for example.

The remote computer 20, in one example, can also be a dynamic host configuration protocol (DHCP) server, which provides a DHCP service. In one embodiment, the remote computer 20 assigns Internet protocol (IP) addresses to the cloud servers 500 using the DHCP service. In one embodiment, the remote computer 20 uses dynamic allocation to assign the IP addresses to the cloud servers 500. For example, when the remote computer 20 receives a request from a cloud server 500 via the network 40, the remote computer 20 dynamically assigns an IP address to the cloud server 500. In one embodiment, the remote computer 20 may be a personal computer (PC), a network server, or any other data-processing equipment which can provide IP address allocation function.

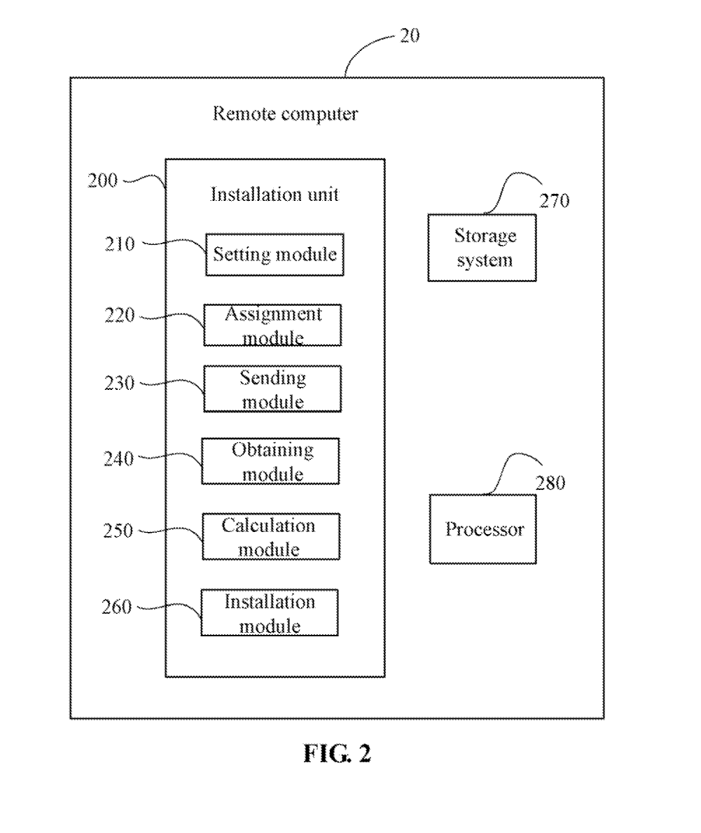

FIG. 2 is a block diagram of one embodiment of the remote computer 20. The remote computer 20 includes an installation unit 200, a storage system 270, and at least one processor 280. In one embodiment, the installation unit 20 includes a setting module 210, an assignment module 220, a sending module 230, an obtaining module 240, a calculation module 250 and an installation module 260. The modules 210-260 may include computerized code in the form of one or more programs that are stored in the storage system 270. The computerized code includes instructions that are executed by the at least one processor 280 to provide functions of the modules 210-260. The storage system 270 may be a memory, such as an EPROM, hard disk drive (HDD), or flash memory.

The setting module 210 sets a configuration file of a virtual machine and a monitoring application, and stores the configuration file and the monitoring application in the remote computer 20. The monitoring application obtains the parameters of each cloud server 500 from the virtual machine management application and sends the parameters to the remote computer 20. The configuration file of the virtual machine includes a number of cores of the CPU required for the virtual machine, the storage capacity of the memory required for the virtual machine, the storage capacity of the disk required for the virtual machine, a CPU utilization rate required for the virtual machine, a memory utilization rate required for the virtual machine, and a NIC utilization rate required for the virtual machine. In other words, the virtual machine is normally installed in the cloud server 500 upon the condition that parameters of the cloud server 500 satisfies requirements in the configuration file of the virtual machine.

The assignment module 220 assigns an IP address by the DHCP service to each cloud server 500 of the data center 50 to communicate with each cloud server 500.

The sending module 230 sends the monitoring application to each cloud server 500. The monitoring application is activated to be available for use in the cloud server 500 when the monitoring application is sent to the cloud server 500.

The obtaining module 240 obtains parameters of each cloud server 500 by the monitoring application and determines available cloud servers 500 according to the parameters of each cloud server 500 and the configuration file of the virtual machine. In one embodiment, the monitoring application obtains the parameters of each cloud server 500 from the virtual machine management application. The cloud server 500 is determined as the available cloud server 500 upon the condition that the parameters of the cloud server satisfies requirements in the configuration file of the virtual machine. In other words, the cloud server 500 does not overload if the virtual machine is installed into the cloud server 500.

The calculation module 250 calculates an installation coefficient of each available cloud server 500. The installation coefficient of each available cloud server 500 is computed by a formula as follow: V=ΣWn*Fn+M, where n represents the number of hardware components, Fn represents a hardware coefficient of the n^{th} hardware component, Wn represents a weight of the n^{th} hardware component, M represents a constant predetermined by a user according to experience of the user. The hardware component may include, but is limited to, the disk, the memory, the CPU, and the NIC. The hardware coefficient of the n^{th} hardware component is computed by a formula as follow: Fn=An*Gn+Tn, where Gn represents a utilization rate of the n^{th} hardware component in the cloud server 500, An and Tn represents constants predetermined by the user according to experience of the user. The installation coefficient indicates a load of the cloud server 500. The greater the installation coefficient is, the less the load of the cloud server 500 is. If the hardware components are the disk, the memory, the CPU, and the NIC, then the utilization rate of the first hardware component may be the disk utilization rate, the utilization rate of the second hardware component is the memory utilization rate, the utilization rate of the third hardware component is the CPU utilization rate, the utilization rate of the fourth hardware component is the NIC utilization rate.

The installation module 260 installs the virtual machine in the available cloud server 500 according to a maximum installation coefficient. In one embodiment, the installation module searches for the image file corresponding to the virtual machine 500 from the remote computer and deploys the image file into the available cloud server 500 corresponding to the maximum installation coefficient.

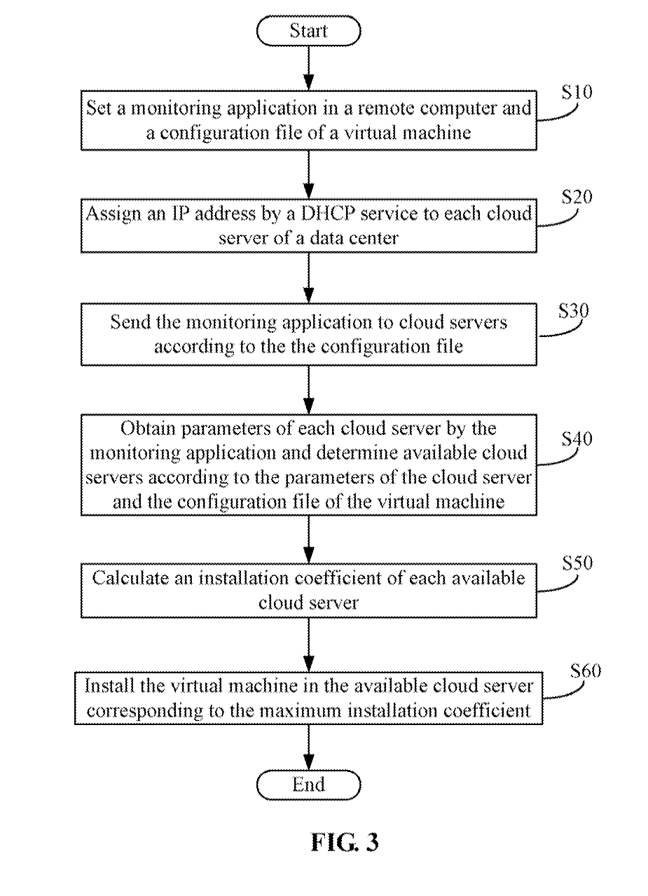

FIG. 3 is a flowchart of one embodiment of an installation method. Depending on the embodiment, additional steps may be added, others deleted, and the ordering of the steps may be changed.

In step S10, the setting module 210 sets a configuration file of a virtual machine and a monitoring application, and stores the configuration file and the monitoring application in the remote computer 20. The monitoring application obtains the parameters of each cloud server 500 from the virtual machine management application and sends parameters to the remote computer 20. The configuration file of the virtual machine includes a number of cores of the CPU required for the virtual machine, the storage capacity of the memory (e.g., random access memory) required for the virtual machine, the storage capacity of the disk required for the virtual machine, and a CPU utilization rate required for the virtual machine, a memory utilization rate required for the virtual machine. In other words, the virtual machine is normally installed in the cloud server 500 upon the condition that the parameters of the cloud server 500 satisfy requirements in the configuration file of the virtual machine.

In step S20, the assignment module 220 assigns an IP address to each cloud server 500 of the data center 50 to communicate with each cloud server 500.

In step S30, the sending module 230 sends the monitoring application to each cloud server 500.

In step S40, the obtaining module 240 obtains parameters of each cloud server 500 by the monitoring application and determines available cloud servers 500 according to the parameters of each cloud server 500 and the configuration file of the virtual machine. As mentioned above, the cloud server 500 is determined as the available cloud server 500 upon the condition that the parameters of the cloud server 500 satisfies requirements in the configuration file of the virtual machine. For example, if the number of cores of the CPU required for the virtual machine is equal to or greater than the number of the cores of the CPU of the cloud server 500, the cloud server 500 is not determined as the available cloud server 500.

In step S50, the calculation module 250 calculates an installation coefficient of each available cloud server 500. The installation coefficient of each available cloud server 500 is computed by a formula as follow: V=ΣWn*Fn+M, where n represents the number of hardware components, Fn represents a hardware coefficient of the n^{th} hardware component, Wn represents a weight of the n^{th} hardware component, M represents a constant predetermined by a user according to experience of the user. The hardware component may be, but is limited to, the disk, the memory, the CPU, or the NIC. The hardware coefficient of the n^{th} hardware component is computed by a formula as follow: Fn=An*Gn+Tn, where Gn represents a utilization rate of the n^{th} hardware component in the cloud server 500, An and Tn represents constants predetermined by the user according to experience of the user. The installation coefficient indicates a load of the cloud server 500. The greater the installation coefficient is, the less the load of the cloud server 500 is.

In step S60, the installation module 260 installs the virtual machine in the available cloud server 500 according to a maximum installation coefficient. For example, assuming that the data center 50 includes three available cloud servers 500, namely A, B, and C, the installation coefficient of available cloud server a is equal to 0.21, the installation coefficient of available cloud server B is equal to 0.46, and the installation coefficient of available cloud server C is equal to 0.72, and the installation module 260 installs the virtual machine in the available cloud server C.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A remote computer in communication with cloud servers of a data center, the remote computer comprising:
at least one processor; and
a storage system, which stores a monitoring application and a configuration file of a virtual machine, and one or more programs when executed by the at least one processor, causing the at least one processor to perform an installation method comprising:
sending the monitoring application to each cloud server;
obtaining parameters of each cloud server by the monitoring application and determining available cloud servers according to the parameters of each cloud server and the configuration file of the virtual machine, wherein the cloud server is determined as the available cloud server upon the condition that the parameters of the cloud server satisfies requirements in the configuration file of the virtual machine;
calculating an installation coefficient of each available cloud server according to the parameters of the available cloud server; and
installing the virtual machine in the available cloud server according to a maximum installation coefficient.

2. The remote computer of claim 1, wherein the parameters of each cloud server comprises a number of cores of a central processing unit (CPU) in the cloud server, a storage capacity of a memory in the cloud server, a storage capacity of a disk in the cloud server, a speed of an interface of the disk in the cloud server, a speed of an interface of a network interface card (NIC) in the cloud server, a disk utilization rate of the cloud server, a memory utilization rate of the cloud server, a CPU utilization rate of the cloud server, and a NIC utilization rate of the cloud server.

3. The remote computer of claim 1, wherein the configuration file of the virtual machine comprises a number of cores of the CPU required for the virtual machine, a storage capacity of the memory required for the virtual machine, a storage capacity of the disk required for the virtual machine, a CPU utilization rate required for the virtual machine, a memory utilization rate required for the virtual machine, and a NIC utilization rate required for the virtual machine.

4. The remote computer of claim 1, wherein the installation coefficient of each available cloud server is computed according to a formula: V=ΣWn*Fn+M, where n represents the number of hardware components, Fn represents a hardware coefficient of the n^{th} hardware component, Wn represents a weight of the n^{th} hardware component, and M represents a constant.

5. The remote computer of claim 4, wherein the hardware coefficient of the n^{th} hardware component is computed according to a formula: Fn=An*Gn+Tn, where Gn represents a utilization rate of the n^{th} hardware component in the cloud server, and An and Tn represents constants.

6. The remote computer of claim 4, wherein the hardware component is selected from a group consisting of a disk, a memory, a CPU, and a NIC.

7. The remote computer of claim 5, wherein the utilization rate of the n^{th} hardware component is selected from a group consisting of the disk utilization rate of the cloud server, a memory utilization rate of the cloud server, the CPU utilization rate of the cloud server, and the NIC utilization rate of the cloud server.

8. A computer-based installation method being performed by execution of computer readable program code by a processor of a remote computer, the remote computer in communication with cloud servers of a data center, the remote computer storing a monitoring application and a configuration file of a virtual machine, the method comprising:
sending the monitoring application to each cloud server;
obtaining parameters of each cloud server by the monitoring application and determining available cloud servers according to the parameters of each cloud server and the configuration file of the virtual machine, wherein the cloud server is determined as the available cloud server upon the condition that the parameters of the cloud server satisfies requirements in the configuration file of the virtual machine;
calculating an installation coefficient of each available cloud server according to the parameters of the available cloud server; and
installing the virtual machine in the available cloud server according to a maximum installation coefficient.

9. The method of claim 8, wherein the parameters of each cloud server comprises a number of cores of a CPU in the cloud server, a storage capacity of a memory in the cloud server, a storage capacity of a disk in the cloud server, a speed of an interface of the disk in the cloud server, a speed of an interface of a network interface card (NIC) in the cloud server, a disk utilization rate of the cloud server, a memory utilization rate of the cloud server, a CPU utilization rate of the cloud server, and a NIC utilization rate of the cloud server.

10. The method of claim 8, wherein the configuration file of the virtual machine comprises a number of cores of the CPU required for the virtual machine, a storage capacity of the memory required for the virtual machine, a storage capacity of the disk required for the virtual machine, a CPU utilization rate required for the virtual machine, a memory utilization rate required for the virtual machine, and a NIC utilization rate required for the virtual machine.

11. The method of claim 8, wherein the installation coefficient of each available cloud server is computed according to a formula: V=ΣWn*Fn+M, where n represents the number of hardware components, Fn represents a hardware coefficient of the n^{th} hardware component, Wn represents a weight of the n^{th} hardware component, and M represents a constant.

12. The method of claim 11, wherein the hardware coefficient of the n^{th} hardware component is computed according to a formula: Fn=An*Gn+Tn, where Gn represents a utilization rate of the n^{th} hardware component in the cloud server, and An and Tn represents constants.

13. The method of claim 11, wherein the hardware component is selected from a group consisting of a disk, a memory, a CPU, and a NIC.

14. The method of claim 12, wherein the utilization rate of the n^{th} hardware component is selected from a group consisting of the disk utilization rate of the cloud server, a memory utilization rate of the cloud server, the CPU utilization rate of the cloud server, and the NIC utilization rate of the cloud server.

15. A non-transitory computer-readable medium having stored thereon instructions that, when executed by a remote computer, the remote computer in communication with cloud servers of a data center, the remote computer storing a monitoring application and a configuration file of a virtual machine, causing the remote computer to perform an installation method, the method comprising:
sending the monitoring application to each cloud server;
obtaining parameters of each cloud server by the monitoring application and determining available cloud servers according to the parameters of each cloud server and the configuration file of the virtual machine, wherein the cloud server is determined as the available cloud server upon the condition that the parameters of the cloud server satisfies requirements in the configuration file of the virtual machine;
calculating an installation coefficient of each available cloud server according to the parameters of the available cloud server; and
installing the virtual machine in the available cloud server according to a maximum installation coefficient.

16. The non-transitory medium of claim 15, wherein the parameters of each cloud server comprises a number of cores of a CPU in the cloud server, a storage capacity of a memory in the cloud server, a storage capacity of a disk in the cloud server, a speed of an interface of the disk in the cloud server, a speed of an interface of a network interface card (NIC) in the cloud server, a disk utilization rate of the cloud server, a memory utilization rate of the cloud server, a CPU utilization rate of the cloud server, and a NIC utilization rate of the cloud server.

17. The non-transitory medium of claim 15, wherein the configuration file of the virtual machine comprises a number of cores of the CPU required for the virtual machine, a storage capacity of the memory required for the virtual machine, a storage capacity of the disk required for the virtual machine, a CPU utilization rate required for the virtual machine, a memory utilization rate required for the virtual machine, and a NIC utilization rate required for the virtual machine.

18. The non-transitory medium of claim 15, wherein the installation coefficient of each available cloud server is computed according to a formula: V=ΣWn*Fn+M, where n represents the number of hardware components, Fn represents a hardware coefficient of the n^{th} hardware component, Wn represents a weight of the n^{th} hardware component, and M represents a constant.

19. The non-transitory medium of claim 18, wherein the hardware coefficient of the n^{th} hardware component is computed according to a formula: Fn=An*Gn+Tn, where Gn represents a utilization rate of the n^{th} hardware component in the cloud server, and An and Tn represents constants.

20. The non-transitory medium of claim 19, wherein the utilization rate of the n^{th} hardware component is selected from a group consisting of the disk utilization rate of the cloud server, a memory utilization rate of the cloud server, the CPU utilization rate of the cloud server, and the NIC utilization rate of the cloud server.
